(19) United States
(12) Patent Application Publication
(10) Pub. No.: US 2010/0139383 A1
(43) Pub. Date: Jun. 10, 2010

(54) APPARATUS AND METHOD FOR MONITORING TYRE WEAR

(75) Inventors: Geoff Haswell, Sheffield (GB); Paul Clarke, Redditch (GB); Manuj Gupta, Leicestershire (GB); Paul Holdsworth, Leicestershire (GB); Gary Pfeffer, Nottinghamshire (GB)

Correspondence Address: GIFFORD, KRASS, SPRINKLE,ANDERSON & CITKOWSKI, P.C, PO BOX 7021, TROY, MI, 48007-7021, US

(73) Assignee: TREADCHECK LIMITED, Worcestershire (GB)

(21) Appl. No.: 12/515,336

(22) PCT Filed: Nov. 19, 2007
(86) PCT No.: PCT/GB07/04414

§ 371 Date: Feb. 11, 2010

(30) Foreign Application Priority Data
Nov. 17, 2006 (GB) 0622978.5
May 30, 2007 (GB) 0710354.2

(51) Int. Cl. B60C 11/24

(52) U.S. Cl. 73/146

(57) ABSTRACT

A fleet management system for monitoring the tread depth of a plurality of tyres in use in a fleet of vehicles, includes an electronic database of information relevant to the depth of tread for each of a plurality of tyres in use in a fleet of vehicles, an apparatus (100) for testing vehicle tyres, the apparatus (100) including eddy current sensors (120) arranged for detecting the relative position of a metallic reference point within a tyre, and an electronic controller for automatically updating said electronic database in response to test data received from said apparatus (100).

The present invention relates particularly, but not exclusively, to apparatus and methods for monitoring the wear of tyres on vehicles. The invention has particular application in vehicle fleet management systems.

There is an increasing onus on car and motorcycle owners to monitor the state of the tread on the tyres of their vehicle(s). Moreover, the operators of vehicles such as trucks, trailers, vans, buses, coaches, and even earth moving plant and agricultural vehicles, are commonly responsible for ensuring that the tread depth on the tyres of their vehicle(s) is within acceptable levels.

Conventionally, tyre wear is monitored using visual inspection. However, this is an imprecise technique and is dependent on the inspector having uninhibited access to the tread of the tyre to be inspected. Hence, this technique is generally unsuitable for vehicles having multiple tyres on each side of an axle, wherein the innermost tyre(s) may be obscured from view or not readily accessed.

DE 19957645 describes an apparatus wherein an eddy current sensor is mounted on a part of a vehicle immediately adjacent one of the vehicle tyres, wherein the tyre incorporates a permanently magnetic region within the tyre tread. The tyre is repeatedly scanned during use, whereby measurements related to tread depth are taken so as to monitor tread wear. However, the position of the sensor in the harsh working environment immediately adjacent the tyre renders it susceptible to damage and/or movement in use, which makes the apparatus unreliable.

It is an object of the invention to provide an alternative apparatus and/or method for monitoring the wear of tyres on vehicles.

According to a first aspect of the invention, there is provided an apparatus for use in monitoring tyre wear comprising a drive-over unit incorporating one or more sensors arranged for detecting the relative tread depth of a tyre, e.g. incorporating one or more eddy current sensors for use in detecting the relative position of a metallic datum within a vehicle tyre.

According to another aspect of the invention, there is provided a method of detecting tyre tread depth and/or monitoring tyre wear including the steps of providing a drive-over apparatus incorporating one or more sensors (e.g. incorporating one or more eddy current sensors), driving a vehicle tyre over said apparatus, and using the or each sensor to detect attributes indicative of tread depth from a tyre that is driven over the apparatus.

In a preferred method, data relating to the sensor readings is communicated to an electronic database of tread depth data, wherein the database may be automatically updated after a drive-over operation using the apparatus set forth above.

The drive-over apparatus and method provides a convenient solution to the problems of reading tyre tread depth, in particular for commercial vehicles such as trucks and trailers, wherein the sensor means is remote from the vehicle and therefore not subject to the daily driving conditions associated with commercial vehicles.

The drive-over apparatus and method can also be of use for testing the tread depth of domestic vehicles such as cars and motorcycles. Police forces, road traffic enforcement authorities and vehicle inspection bodies can also use the apparatus and method as part of roadside testing or the like.

According to another aspect of the invention, there is provided a fleet management system for monitoring the tread depth of a plurality of tyres in use in a fleet of vehicles, the system incorporating: an electronic database of information relevant to the depth of tread for each of a plurality of tyres in use in a fleet of vehicles, an apparatus for testing vehicle tyres, which apparatus is configured to generate values that can be used to indicate the depth of tread on a particular tyre under test, and an electronic controller for automatically updating said electronic database in response to test data received from said apparatus.

In preferred methods and systems of the invention the electronic database may include data relevant to specific tyres, for example the tread depth of a specific tyre on a known date (e.g. on the tyre's first day of service), whether manually recorded or automatically recorded using the drive-over apparatus. The database may include tread depth data for subsequent dates.

The database is preferably configured for access via the Internet or another form of electronic interface. In preferred embodiments, the database is only accessible by authorised users, for example users having a specific password. Examples of authorised users preferably include those persons responsible for the maintenance and road worthiness of the vehicle and/or tyre in question.

The database can be used to generate an electronic notification regarding the tread state of a particular tyre, in particular if the database reveals that the latest reading from the apparatus is below an acceptable threshold. Subsequent warnings may be generated if no remedial action has taken place, e.g. if a subsequent reading from said apparatus is below the previous reading.

The apparatus used in the above system preferably comprises a drive-over unit incorporating one or more sensors arranged for detecting the relative tread depth of the tyre, e.g. of the kind set forth above, and more preferably an apparatus incorporating one or more eddy current sensors.

The system may incorporate a network of drive-over units arranged at a plurality of remote regional, national and/or international locations, each unit being configured to generate values that can be used to indicate the depth of tread on a particular tyre under test. The drive-over units are preferably arranged at the entrance or exit of a vehicle compound or loading bay, whereby vehicle tyres can be tested prior to commencement of and/or upon return from a journey. Additionally or alternatively, it may be preferred to incorporate or locate one of said units at the end of a tyre production line and/or a vehicle assembly line and/or at a vehicle maintenance location.

The system is applicable for managing a fleet of trucks and trailers, as well as other commercial or non-commercial vehicles such a fire engines, ambulances, postal vehicles, public transport vehicles, agricultural vehicles, earth moving vehicles and other wheeled plant. The system is also of use for managing a fleet of police vehicles, for example police motorcycles, police cars and other associated vehicles.

A drive over apparatus for use in any of the above aspects of the invention may be configured for unidirectional operation, whereby sensor readings are only processed, e.g. by a local controller, if the apparatus is driven over in a predetermined direction, e.g. in an ‘incoming’ direction when the apparatus is positioned at the entrance to a vehicle compound or the like. Alternatively, the apparatus may be bi-directional, e.g. whereby the sensor readings are processed if the vehicle is incoming or outgoing. In other embodiments, the apparatus may be multi-directional, whereby sensor readings are processed irrespective of the direction of travel of a vehicle over the sensors.

In preferred embodiments, the apparatus includes multiple sensors, each sensor having a dedicated PCB configured to receive data from the sensor. Alternatively, the apparatus may include two or more groups of sensors, each group of sensors communicating with a respective PCB. The PCBs are preferably arranged in communication with a transmitter unit within the apparatus, e.g. via a bus or electrical cable(s), for wireless communication with an external processor. However, in other embodiments, data from the PCBs may be communicated to an external processor by cable. In a simplified embodiment, the sensors communicate directly with a remote processor, i.e. without an intermediate PCB or transmitter unit.

Data from the sensors may be packaged with additional data specific to the tyres under test, such as tyre pressure data from pressure sensors forming part of, or arranged in conjunction with, the apparatus.

The apparatus may include a receiver device for receiving data from a tyre or vehicle under test, and/or from a remote processor, in which case the transmitter unit referred to above is preferably a transceiver device for use in transmitting and receiving data.

The apparatus for use in any of the above aspects of the invention may include an array of sensors defining a sensor envelope which is greater than the static foot print of a standard vehicle tyre of the type most likely to be used with the apparatus, or greater than the static foot print of a combination of vehicle tyres (e.g. two side by side tyres on one end of a vehicle axle). The sensors can be arranged to measure or detect variance in tread depth across the width of a tyre, e.g. to report that the tread is wearing unevenly from tyre shoulder to tyre shoulder.

Other aspects and features of the invention will be readily apparent from the claims and following description of preferred embodiments, made by way of example only, with reference to the accompanying drawings in which:

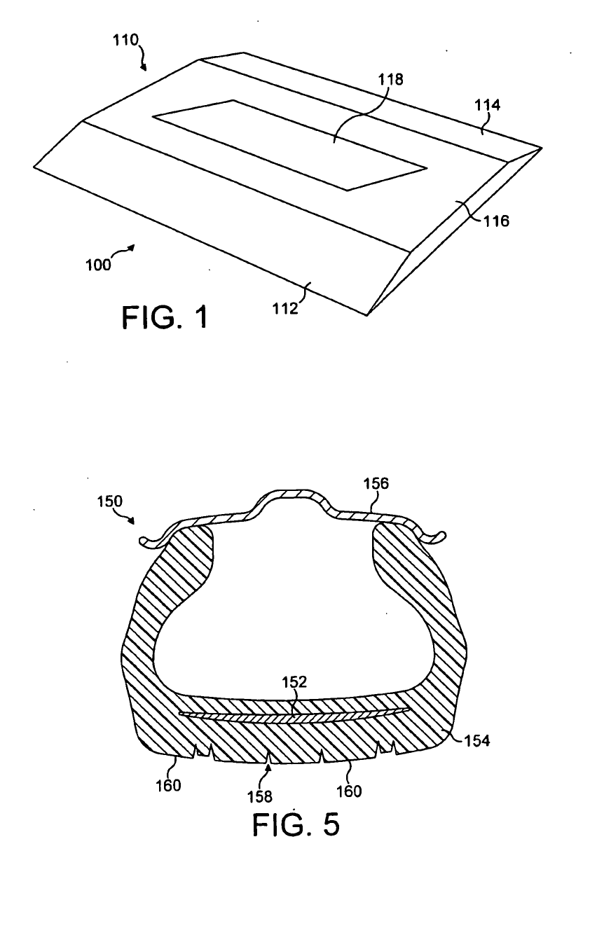

FIG. 1 is a schematic perspective view of a drive over apparatus in accordance with a preferred embodiment of the invention;

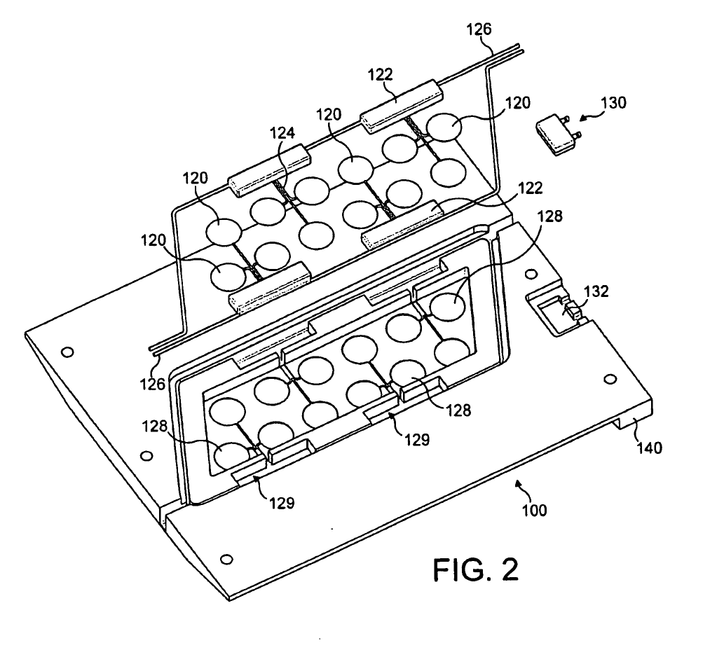

FIG. 2 is a semi-exploded view from the underside of the apparatus shown in FIG. 1;

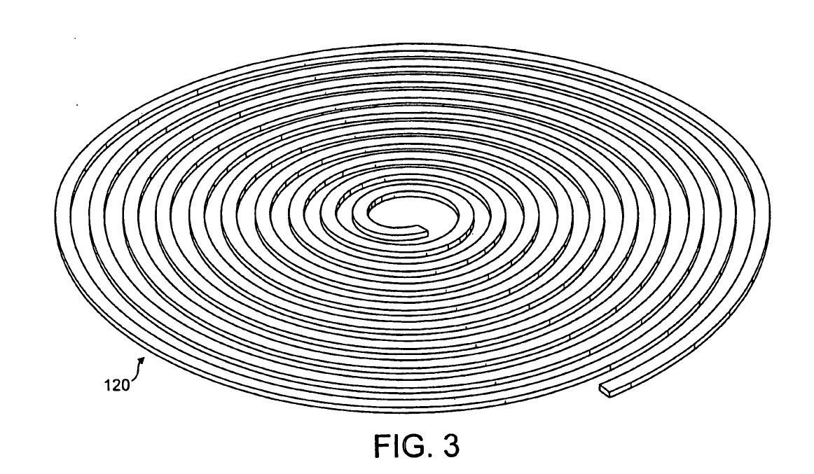

FIG. 3 is a schematic perspective view of a preferred sensor for use in the apparatus of FIG. 1;

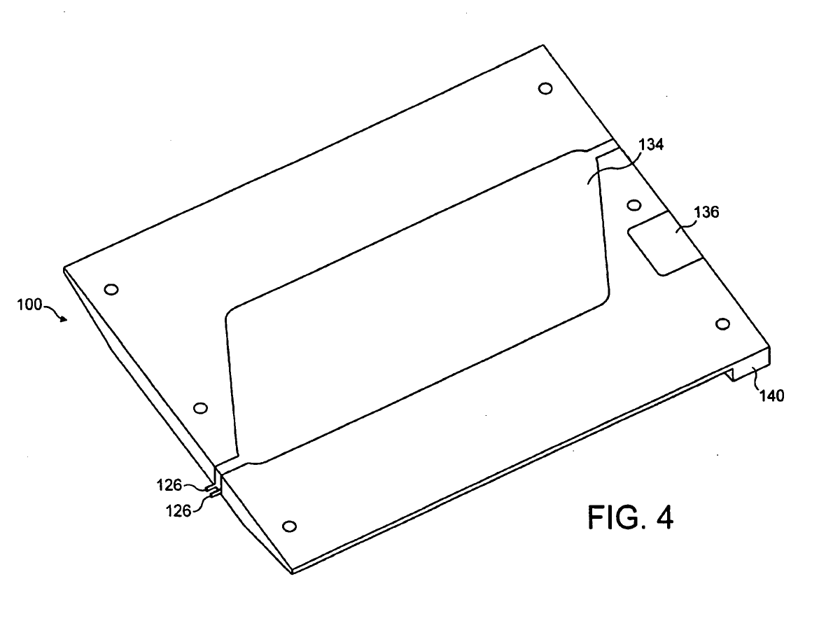

FIG. 4 is a view similar to FIG. 2, showing the internal components of the apparatus enclosed therein by a cover material;

FIG. 5 is a schematic cross-section through part of a preferred tyre for use with apparatus in accordance with the invention; and

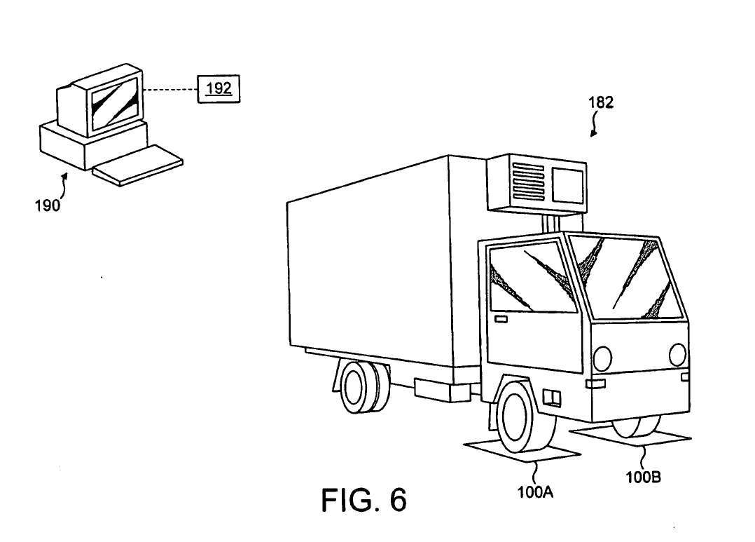

FIG. 6 is a schematic view of a computer arranged in communication with an apparatus mat of the kind shown in FIG. 1.

An example of an apparatus for use in monitoring tyre wear is indicated generally at 100 in FIG. 1. The apparatus consists of a body 110 having front and rear ramp sections 112, 114, which are arranged on opposing sides of a central section 116. The ramp sections 112, 114 may be excluded in other embodiments.

As will be described in more detail below, one or more sensors (not shown) are housed in the body 110. The or each sensor is preferably mounted beneath a thin walled cover 118, so as to be located immediately adjacent -yet directly protected from—any tyre being driven over the apparatus 100 in use.

Preferably, the or each sensor is sealingly mounted within the main body 110, so as to be protected from oil or other liquids from the environment of the vehicles being tested.

The apparatus 100 may include a guide for use by a person driving over the apparatus 100, e.g. for use in aligning a vehicle with the apparatus, in order to ensure that the tyres to be tested pass over the sensors 120 in a preferred manner. In this embodiment, the guide takes the form of an upstand 140 (not included in FIG. 1 but visible in FIGS. 2 and 4) formed along one side of the main body 110. A corresponding guide may be formed on the opposite side of the body and/or other visual aids may be included, e.g. a direction arrow down the centre of the body.

In the illustrated embodiment, the apparatus 100 is wide enough to accommodate two side-by-side tyres, such as might typically be found at the driving axle of a tractor unit, large coach or haulage trailer. However, the apparatus may be made smaller for use in accommodating single tyres, for example on a standard passenger car or motorcycle. Alternatively, the apparatus can be made much larger, e.g. so as to be wide enough to accommodate the wheels on both sides of a vehicle axle, in which case it may be preferable to have separate sets of sensors for recording data from the respective sides of the vehicle. Otherwise, two separate drive over units 100A, 100B can be used, one for each side of a vehicle, e.g. as shown in FIG. 6.

FIG. 2 shows an example of a preferred array of sensors 120 for use in the apparatus 100. The sensors 120 define transverse rows, which are intended to be located centrally within the main body 110. In this embodiment, the sensors 120 are eddy current sensors. In the illustrated embodiment, the sensors 120 are uniformly spaced in four triangular sets.

The main body is preferably non-metallic, for example made from nylon or plastics, so as not to interfere with the magnetic field generated by the eddy current sensors. The sensors may be cast in the body, e.g. so as to be immovable without breaking in to the body.

FIG. 3 shows an example of a suitable form of eddy current sensor 120 for use with the apparatus 100, in the form of a generally planar copper coil, which is intended to be mounted in a horizontal plane in the apparatus 100, so as to be generally parallel with the upper surface of the body 110. However, in alternative embodiments non-planar coils may be used, e.g. one or more wires wound on a bobbin.

Referring back to FIG. 2, each sensor has a dedicated PCB (not shown), which is configured to receive a signal from the sensor via a wire or cable 124. For convenience of packaging, the PCBs for each set of sensors 120 are housed in a controller box 122. PCBs are arranged in communication with a transmitter 130 within the apparatus, e.g. via a bus or electrical cable 126, for wireless communication with an external processor (e.g. The computer 190 in FIG. 6). However, in other embodiments, data from the PCBs may be communicated to the external processor by cable. In a simple embodiment, the sensors communicate with a single PCB. In other embodiments, the sensors communicate directly with an external processor, i.e. without an intermediate PCB or transmitter unit.

The transmitter 130 is preferably a transceiver unit, arranged for transmitting and receiving data.

The body 110 defines internal recesses into which the sensors 120, controller boxes 122, wires 124, buses 126 and transceiver unit 130 are mounted. In particular, circular apertures 128 are provided for the sensors 120 and rectangular channels 129, 132 are provided for the controller boxes 122 and transceiver unit.

FIG. 4 shows the apparatus 100 in a fully assembled state, wherein a cover or backing 134 sealingly encloses the sensors 122 within the main body 110.

In a preferred method of use, each eddy current sensor 120 is permanently energised, whereby each sensor generates a magnetic field. The associated PCBs generate a control or ‘free air’ reading associated with a normal operating condition, in which the associated sensor is energised and there is no external object positioned on the apparatus above the sensor.

It will be understood that a change in magnetic field will occur if an object is placed over one of the energised eddy current sensor 120. Hence, if a tyre passes into the magnetic field generated by any of the sensors, a change in reading is experienced, indicative of the change in magnetic field.

FIG. 5 shows an example of a tyre 150 having an annular steel band or belt 152 embedded within the tyre material 154. The belt 152 is generally parallel to the plane of the effective road contacting surface 160 of the tyre tread, as opposed to a metallic element mounted in the side wall of the tyre. It will be understood that as the tread 158 of the tyre wears during use, the distance from the effective road contacting surface 160 of the tyre to the steel belt 152 reduces.

The apparatus 100 can be used to give readings indicative of the relative height of the steel belt from sensors within the main body, for example by driving the tyre over the apparatus 100 and comparing the changes in magnetic field from earlier readings. In a preferred method of monitoring tyre wear, one or more control readings are taken by driving a tyre over the apparatus at a time when the initial depth of tread 158 and the position of the steel belt 152 relative to the drive surface 160 of the tyre 150 is known, e.g. when the tyre is new or substantially unused. Readings taken during the life of a tyre can then be compared against these control readings.

The test data is preferably stored in a database, e.g. the database 192 indicated in FIG. 6, which is accessible via a remote processor 190. Sensor data which is indicative of the minimum allowable tread depths for each type of tyre to be tested may also be stored. Tyres can then be assessed as part of a periodic maintenance check of a vehicle, e.g. as part of a six weekly check. The data from later assessments can then be compared against the minimum threshold readings and the control readings, to determine whether the tread depth has worn beyond an acceptable level, for example.

The database may include sensor data indicative of the typical pattern of tread wear for a particular type of tyre from new to an unacceptable depth of tread, e.g. based on mileage and/or road hours and/or road conditions (e.g. summer/winter conditions) and/or usage conditions (e.g. under maximum trailer or passenger load). Data from tests carried out using the apparatus and/or method of the invention can be used for comparison against the information in said database. For example, the database can be used to predict whether a given tyre is likely to wear down beyond an acceptable level in the immediate period following a particular test date, by comparing the test history of the tyre/vehicle against predicted future usage and the information in the database.

The data recorded as part of tests carried out using the apparatus may be transmitted to and stored on an electronic device in the associated vehicle, as well as in a central database. The stored data is then readable at any time, e.g. by haulage staff or road vehicle safety staff, to assess the tread wear test history of the vehicle. The data is preferably presented on a web or Internet based interface for remote access and monitoring.

To initiate a test using the apparatus, the apparatus is preferably configured for receiving a signal from an approaching vehicle, which signal can be used to identify the vehicle in question and/or to identify the arrangement of tyres to be tested. For example, each vehicle and/or tyre may include a unique RF ID Tag or other known means that can be used as a unique identifier as the vehicle approaches the apparatus 100. In the illustrated embodiment, the transceiver 130 is able to communicate with an approaching vehicle, to receive data relevant to the tyres on the vehicle, e.g. the relative position of the tyres on the vehicle.

There will now be described a particularly preferred method for use of the apparatus 100, wherein the apparatus is used in the management of a fleet of trucks and trailers, with reference to FIG. 6.

In this method, two drive over units 100A, 100B are used, one for each side of a vehicle 182 (consisting of a truck unit 184 and trailer unit 186). Each unit 100A, 100B includes an array of eddy current sensors of the kind described above, and the units 100A, 100B are arranged for wireless communication with a central controller in a remote computer 190. A database 192 of test data and typical tread wear data is preferably held on or accessible via the computer 190.

Each unit 100A, 100B and/or the central controller is preferably configured to identify the vehicle 182 under test. This may be via Automatic Number Plate Recognition (ANPR) or other means, for example by wireless communication with an in-cab or on-trailer device, and/or by communication with the individual wheels/tyres. The trailer 186 may be identified directly or by association with the truck 184, e.g. by reference to a database containing the relevant truck and trailer data, when it is known that a particular truck is in operative association with a specific trailer. By identifying the truck/trailer combination the layout and identification of the tyres under test can be determined, so that the results taken during the test can be assigned to the correct tyres, e.g. by comparing the order that the test results are received against a known tyre map for the vehicle.

It is preferred if the central controller is able to complete the tyre mapping process before the vehicle is driven over the units 100A, 100B. A traffic light type system can be employed to indicate to a driver when the mapping process has been completed and the apparatus is ready for the test.

The eddy current sensors are energised, so as to create ‘free air’ readings. The lead axle of the truck 182 is driven over the two units 100A, 100B, thereby generating a stream of sensor data from each unit 100A, 100B which is indicative of the position of the metallic datum within each tyre relative to the sensors in the respective units 100A, 100B. A similar data stream is generated for each subsequent axle of the truck/trailer combination.

A period of time may be required from initial energisation of the sensors, in order to allow the free air readings to stabilise. A traffic light system or other signal can be provided to inform a user that the sensors are suitably stable.

Once the vehicle has passed over the two units 100A, 100B, the test data is collated as a data packet within the apparatus (e.g. via a processor associated with or forming part of the transceiver unit 130), which is then transmitted to the central controller (e.g. via a GSM network). Alternatively, the data streams may be communicated to the central controller in real time. The free air readings and tyre readings are immediately identifiable from the data streams.

The central controller 190 collates the data, then looks at the tyre map, in order to compare the recorded data with known data for each tyre. The central controller then updates the test history for each tyre, for example by updating the online database 192.

In accordance with preferred methods and systems of the invention, readings taken as a vehicle is driven over the apparatus can be used to operate a traffic light system or other alert system, either adjacent the apparatus or in the cab of the vehicle, for example. The alert system can be used to provide a visual and/or audible signal to the driver of the vehicle or the test operator as to whether or not the tyres under test have a road worthy tread depth. Such a system can also be used to indicate that an unacceptable tread depth is imminent, for example.

It may be preferred to ensure that the vehicle passes over the apparatus at a predetermined speed maximum and/or minimum speed, to ensure that the sensor readings are repeatable. The central controller and/or apparatus can be configured to communicate with the vehicle to detect speed or to provide a visual indicator (via an external display) of the maximum speed to be employed when driving over the vehicle, and/or an audible indicator if the preferred maximum speed has been exceeded, or vice versa.

In the embodiment of FIG. 1, the apparatus is in the form of a mat which is intended to be driven onto and/or over by a vehicle. The mat is intended to be readily moved from one location to another. In the alternative, the apparatus 100 may be formed as a permanent ‘drive-over’ fixture, e.g. with its upper surface arranged at ground level in a testing area. The apparatus may be located above or below ground, and so ramps may be provided for use in driving a vehicle onto the main body.

A weight sensor can be incorporated into any portion of the body, or in an extension thereto, whereby the weight of the vehicle can be measured as it drives over the mat. Pressure sensors may also be included.

In a most simple embodiment of an apparatus in accordance with the invention, only a single sensor is provided in the body of the apparatus. More preferably, the sensor is permanently energised and a continuous stream of data is communicated to the central controller, e.g. via a wireless or cable link.

It will be understood that the readings from a tyre may vary across the width of the tyre. Hence, there is a risk with single sensors that the tyre may not pass directly over the main body of the sensor, thereby providing inaccurate assessment data. Therefore, it is preferred if two or more rows and/or columns of sensors are provided, wherein the X and Y dimensions of the sensor array and/or the dimensions of the magnetic field generated by the sensors under normal operating conditions, is greater than the static foot print of a standard vehicle tyre of the type most likely to be used with the apparatus, so that the tread of the tyre will always pass over the apparatus within the envelope defined by the sensor array, provided that the tyre is driven over the apparatus in a predetermined direction. The use of multiple sensors allows an average reading to be computed and other data such as minimum and maximum values to be extracted.

Each sensor or associated set of sensors in the apparatus can be located in discrete modules removably mounted within the body of the apparatus, for simple replacement or maintenance. The case of eddy current sensors, each sensor is preferably potted in a suitable non-electrical and non-magnetic compound, to protect the sensors from deformation and interference, in use.

The apparatus may include its own power supply, e.g. a battery. The apparatus may include a standby or other low power ‘sleep’ mode, wherein the sensors are only energised as a vehicle approaches the apparatus. Hence, the apparatus may include pressure sensitive sensors, e.g. in the ramp or other access sections of the apparatus, for detecting that a vehicle is approaching the sensors. Alternatively, the central controller can be triggered to wake from its sleep mode to energise the sensors, if the apparatus or the central controller detects a wireless communication from an approaching vehicle, for example.

1. Apparatus for monitoring tyre wear, the apparatus comprising a drive-over unit incorporating one or more eddy current sensors for detecting the relative tread depth of a tyre driven on to the body.

2. Apparatus according to claims 1 wherein the sensors are mounted in a drive over body of non-metallic material.

3. Apparatus according to 2 wherein the or each sensor is set in a non-metallic, non-magnetic potting compound.

4. Apparatus according to any of claims 1 to 3 wherein unit has a drive-over surface, and wherein the or each sensor is located proximate said drive-over surface so as to be located adjacent a tyre under test as it is driven on to said surface.

5. Apparatus according to claim 4 wherein the sensors are in the form of planar coils mounted parallel to the drive over surface.

6. Apparatus according to any preceding claim wherein the or each sensor is cast within the body.

7. Apparatus according to any preceding claim wherein the unit is in the form of a mat having entry and exit ramp sections.

8. Apparatus according to any of claims 1 to 7 wherein the unit includes a transmitter for transmitting data from the sensors.

9. Apparatus according to any preceding claim, incorporating a receiver for wireless communication with an approaching test vehicle.

10. Apparatus according to any preceding claim, the apparatus including multiple sensors configured generate a magnetic field envelope which is greater in plan view than the static foot print of a typical vehicle tyre.

11. A method of monitoring tyre wear including the steps of providing a drive-over apparatus incorporating one or more eddy current sensors, driving a vehicle tyre over said apparatus, and using the or each sensor to detect attributes from the tyre indicative of tyre tread depth, wherein the tyre to be monitored incorporates a metallic reference datum and the method employs the sensors to detect the position of the reference datum relative to the road contact surface of the tyre, as the tyre is driven over the apparatus.

12. A method according to claim 11 wherein the reference datum is embedded within the tread wall of the tyre.

13. A method according to claim 11 or claim 12 wherein the method includes the step of taking one or more control readings by driving a tyre over the apparatus at a period when the depth of tread on the tyre is known, and storing said readings for comparison with later readings.

14. A method according to any of claims 11 to 13 wherein the method includes the step of comparing data from the sensors as the tyre is driven over the apparatus with a database of sensor data indicative of the minimum allowable tread depth for the tyre.

15. A method according to any of claims 11 to 14 wherein the method includes the step of providing a database of sensor data indicative of the typical pattern of tread wear for the life of a tyre to be monitored, and comparing the data from the sensors when the tyre is driven over the apparatus against said database to indicate the tread state of the tyre.

16. A method according to claim 15 wherein the method includes the step of providing an alert if the tread state of the tyre is below a predetermined threshold in said database.

17. A method according to claim 16 wherein the method includes the step of activating a traffic light system to provide a visual signal to the driver of the vehicle under test or a test operator indicative of the tread state of the tyre.

18. A method according to claim 16 wherein the alert is provided via SMS and/or email.

19. A fleet management system for monitoring the tread depth of a plurality of tyres in use in a fleet of vehicles, the system incorporating: an electronic database of information relevant to the depth of tread for each of a plurality of tyres in use in a fleet of vehicles, an apparatus for testing vehicle tyres, the apparatus configured to generate values that can be used to indicate the depth of tread on a particular tyre under test, and an electronic controller for automatically updating said electronic database in response to test data received from said apparatus.

20. A system according to claim 19 wherein the apparatus comprises a drive-over body incorporating one or more sensors arranged to communicate with a vehicle tyre, for detecting the relative tread depth of the tyre.

21. A system according to claim 20 wherein data relating to the sensor readings is automatically communicated to said database.

22. A system according to claim 21 wherein the database is configured to automatically update the tread depth data for a tyre after a drive-over operation.

23. A system according to any of claims 19 to 22 wherein the database is configured for access via an electronic interface.

24. A system according to claim 23 wherein the database is configured for access via the Internet.

25. A system according to claim 23 or claim 24 wherein the database is only accessible by authorised users.

26. A system according to any of claims 19 to 26 incorporating an apparatus in accordance with any of claims 1 to 10.

27. A system according to any of claims 19 to 26 incorporating the method steps of any of claims 11 to 18.

28. A method of monitoring tyre wear including the steps of providing a drive-over apparatus incorporating one or more sensors, driving a vehicle tyre over said apparatus, and using the or each sensor to detect attributes from the tyre indicative of tyre tread depth.

29. Apparatus for use in monitoring tyre wear comprising a drive-over unit incorporating one or more sensors arranged for detecting the relative tread depth of a tyre.
